(19) United States
(12) Patent Application Publication
(10) Pub. No.: US 2014/0273051 A1
(43) Pub. Date: Sep. 18, 2014

(54) CHEMICAL SENSING APPARATUS HAVING MULTIPLE IMMOBILIZED REAGENTS

(71) Applicants: Rakesh Reddy, Deerfield Beach, FL (US); Bruce Johnson, Deerfield Beach, FL (US); Kevin Doyle, Deerfield, FL (US)

(72) Inventors: Rakesh Reddy, Deerfield Beach, FL (US); Bruce Johnson, Deerfield Beach, FL (US); Kevin Doyle, Deerfield, FL (US)

(21) Appl. No.: 13/844,172

(22) Filed: Mar. 15, 2013

(51) Int. Cl. G01N 21/75

(52) U.S. Cl. CPC G01N 21/75
USPC 435/25; 436/164; 435/288.7; 422/82.08; 435/34; 435/287.9

(57) ABSTRACT

An apparatus sensing two or more reactants or analytes in a sample is provided. The apparatus has an one or more light sources emitting energy with two or more detection targets having an immobilized reagent within the target surface. One or more detectors are provided where the two or more detection targets having immobilized reagent thereon are in communication with the sample and the immobilized reagent interacts with the sample. Energy is incident on the targets from the at least one light source such that the energy is changed by the interaction and the change is in turn detected by the at least one detector and associated with a measurement of the level of the reactant or analyte in the sample. A method of making a sensing apparatus and a method of sensing using the sensing apparatus are also disclosed.

### BACKGROUND OF THE INVENTION

1. Field of the Invention

The instant invention is generally directed to an apparatus and method of chemical sensing, utilizing multiple targets having immobilized reagents or reactants in a material matrix forming discrete sensors or targets for physical and chemical reaction sensing through spectrographic analysis of the immobilized analytes with the targeted components in the sample. More specifically, the instant invention includes an apparatus for analyzing solution sample variables using a light source incident on at least two components with immobilized analytes that examines spectrographic changes at the components with the immobilized analytes to determine properties of one or more desired variables.

2. Background of the Invention

Chemical sensors and chemical sensing technology have formed a basis of scientific investigations and technological developments throughout history. Through the centuries vigorous efforts have continued to be directed toward improving sensors. Efforts to improve accuracy, speed, and reduce overall costs continue to drive the market in sensor development. In particular, sensing specific analytes in conjunction with reagents instigating a response in a solution which has applications in many fields, from medicine to waste treatment for example, has been an area of great interest. Given the wide ranging need for such sensors, improvements and adaptation of new technologies in such sensors have a potentially substantial return.

There are several ways in which concentrations of components of a solution can be sensed. In some examples, such as measurement of pH sensing via a concentration of hydronium ions can be done. The electrochemical properties of an analyte can be used to produce an electrical signal at a specially designed probe. In the in-situ situation when these types of sensors are used, such use requires frequent calibration to ensure that drifts in measurement are accounted for due principally to accumulation of deposits from the electromechanical reaction on the sensor. Further the complex design of the electrode makes it expensive and the probes need careful considerations during shipping, handling, and installation. Also, not many other analytes of interest in a typical solution respond via an electromotive force at the target electrodes. As a result, this technique cannot be applicable for sensing a number of analyte reactions, significantly limiting the usefulness of any resulting sensors based on this technology. Additionally, the electrodes do not give a reproducible electromotive force over long periods of time, again due to fouling, thus reducing the operational life of the sensor. Lack of accuracy, shorter operational life, and a requirement to correct for this fouling or drift through frequent calibration relegates this type of measurement to laboratories and hampers real world deployment without significant drawbacks to accuracy and very high operational costs for deployment. For instance some sensor packages using this technology are used to do chemical analysis in pools. The resulting sensor packages are difficult to use, require constant maintenance and are not as accurate due to the nature of the sensors/type of sensing used.

Another ubiquitous method of testing concentration of reactants/analytes in a solution is through observation of the effect that the reactant has on a reagent that is specifically designed to interact with the reactant. This system of testing can range from reagents that change their absorption properties to those that create detectable precipitates and vary in delivery method from liquids, ranging from sprays to liquids in beakers, to paper impregnated strips. Reagents that exhibit chromism, e.g. change color, can exhibit this in different ways, including for example, but certainly not limited to absorption of incident or reflected light, absorption of energy and readmission in the same spectrum, absorption of light followed by the emission of light in a different spectrum, the change in the polarization characteristics of the light or the like. However, one of the many drawbacks of such detection methods is the addition of a reagent to a sample to instigate a color changes can result in uncontrolled absorption of the reagent by the reactant making re-sampling a necessity and potentially skewing any measurements. These systems excel, therefor, in detecting one off reactions without regard for absorption or fouling of the sample with the reagent, for instance in a laboratory where mixing in test tubes is sufficient and visual detection of changes with is sufficient, this process is useful. However, in preparing large numbers of samples or where higher accuracy measurements against the sample are needed or where consistent, high repetition, real time sampling is needed, these systems simply cannot work.

Some companies have adapted the color changing sampling technique and made systems in which those reagents are automatically, in small quantities, made to come in contact with the solution with analytes on a test strip or automatically added thereto. Devices currently available include the Hanna Instruments HI 2210 and HI208-02 Benchtop pH Meters and the Sper Scientific 860031 Benchtop pH/MV Meter and the like in the realm of pH sensors. The optical changes in the chamber are measured using a variety of optical detection techniques or electrical techniques and values are displayed. The disadvantages here are these systems tend to be complex systems which require liquids to be moved around from container to container, they require reapplication of solutions and reagents need to be restocked, calibration is required each time to calibrate batches of reagents after restocking and often in between measurements, and upfront cost and operations costs are high. And like in the case of electrical probes, the system additionally suffers as described above from fouling. It is also atypical to have more than one variable measured by such a system. Additionally, these provide a slightly higher level of accuracy than the visual color change indicator tests, but still fail to achieve the accuracy needed for some applications.

One solution to provide for more quantitative purposes with a reactant/analyte mixture require placement of the solution in an optical cuvette. The cuvette is then engaged with a spectrometer. The spectrometer can be used to show changes in absorption, fluorescence, and measures more accurately the degree of the reaction being observed. The disadvantages of this system are myriad, firstly it is still fraught with human error, for instance from human handling and constant changing of reagent stock and supply, as well as higher overall system costs and maintenance and operation costs. It is also slow and requires a large amount of bench time from highly skilled professionals to operate.

Some devices have taken this technique and made single cuvette systems in which single cuvettes are introduced to reagents with a solution with analytes in a chamber. The optical changes in the chamber are measured with one a variety of detection techniques and values are displayed. However, these solutions still only provide a specific analysis on a single sample basis, limiting the search to a single reagent/reactant analysis. Additionally, these solutions still result in overly complex systems requiring liquid solutions be handled and used to “fill” multiple samples with the reagent for analysis in the sample. This then has to be repeated for each sample and, potentially, recalibrated for each new sample. This is as a direct result of one of the principal drawbacks of the liquid/liquid on strip reagent sensing system, the reagents need to be restocked and thus the cost upfront and the cost of operation are increased, not to mention the overall cost of lab technician labor time. Additionally, as the reagents will require consistent reapplication or restocking, constant calibration continues with these systems as well and is a source of error in these systems. An example of such a system is Lamotte WATERLINK SPIN analysis machine, which can process a number of analytes for a specimen. However, the processing still requires a consumable, here a disk, with the analytes.

Recent advances in material and molecular sciences have dramatically increased the pace of advances to address some of these issues, as evidenced by the instant invention. In particular, improvements in technology and reagent delivery materials and structure have provided ever-increasing improvements in accuracy and cost effectiveness of sensors. One difficulty with reagent reactions is effective immobilization of the reagent for repetitive interaction with test sample without loss of the reagent through absorption or reactions with the reactant. One new technology for effective immobilization of reagents for sustainable and repeatable sensor gathering is Sol-Gel materials technology.

Sol-Gel materials technology has developed to provide manufacturing techniques for producing a class of materials with wide ranging applications, from dense ceramics to aerogels. The method provides for, in some instances, low temperature manufacturing of matrix structures on surfaces, bulk material, or as other products and structures. The Sol-Gel technique provides high purity, homogeneity, controlled porosity, stable temperature characteristics and nanoscale structuring for generating highly sensitive and selective matrices to incorporate reagent molecules in a surface or throughout the sol-gel structure via pores. Generally, the process involves the transition of a liquid or ‘sol’, the colloidal suspension of particles, with a precursor that is then introduced to an at least one solvent into a solid ‘gel’ thereby forming intermediary polymer structures with some specialized properties. The intermediary structures, collectively referred to herein as a xerogels, are then dispersed in any number of techniques and dried to form various structures.

A typical method of manufacture is described hereafter. Although a description of a form of sol-gel production is provided herein, the example is meant to be non-limiting. Other forms and formats for creating sol-gel materials can be used without departing from the spirit of the invention with a goal of providing a porous structure with embedded, immobilized reagents. In a principal step of a typical manufacturing process of a sol-gel material, hydrolysis of the colloidal components is conducted. This is where a precursor such as Tetraethoxy silane (TEOS), Tetrametjoxy silane (TMOS), Methyltrimethoxy silane (MTMOS) or other metal alkoxides are hydrolyzed. The hydrolysis requires a catalyst typically a very small amount of water or acid or the like. Since these metal alkoxides are not immiscible in water, a solvent such as a base alcohol suitable for the metal alkoxide, for instance in the case of TEOS an ethanol, can also be used for phase transitions.

Following hydrolysis, the condensation of the material occurs where the individual precursor molecules start connecting to each other. The material then begins gelation where the system forms a viscous liquid. This is the step where the reagents will typically be added. Further cross-links on the molecular level are formed within the viscous liquid through a process called ageing. Ageing can also be accompanied by mechanical manipulation of the product. For instance, one example of forming a thin film can be, but is certainly not limited to, spin coating which is used to form a thin layer of xerogel. The xerogel is then dried such that alcohol/water in the solution is lost and all structural bond formations are completed. Post processing from a bulk material with the matrix structure and immobilized reactant can also occur to produce the sensor material. Finally, a process called densification can be used to thermally treat and collapse the open structures to form a dense ceramic.

The result of this method allows for the design of desired materials at low temperatures with matrices ideal for encapsulating or engulfing further molecules, the structure of which is converse to the extreme temperatures typically found in manufacturing complex matrices. The result is a matrix structure that acts as porous binders for reactants or reagents. By retaining the open structure and with the additional reagents added during formation, the reagents trapped or immobilized in the spaces formed by the M-O-M bonds where M can be any metal from the precursor or combination of precursors, for instance Si—O—Si bonds.

In a further effort to fix or immobilize the reagent and prevent so called leaching over time of the reagent with the reactants, it is possible to introduce modifying fixing agents in the process of preparing the reagent. For example the modifying agents can be, but are certainly not limited to, molecules that affect the bonding of the reagents such as a trialkoxysilane when the precursor is tetraoxysilane. These agents would act to modify the reagent so that it covalently bonds to the matrix. This eliminates any leaching and further immobilizes the reagent in the sensor as an end result. Similarly, one could use a reagent that allows for it to bond chemical with the matrix using a hydrogen bond or ionic bond or the like. Additional surfactants can be used, such as but not limited to cationic trumethyl ammonium bromide, anionic sodium dodecyl sulfate, and the like. In the case of the Sol-Gel matrix created by the lower temperature processes, by adding a recognition reagent element in the Sol-Gel matrix during synthesis the resulting surface can be effectively made into a longer lasting reagent delivery surface. In the process of gel forming this can be accomplished by doping or by grafting a reagent which does not interact chemically with the surroundings during the matrix formation process. This recognition or template molecule associated with the reagent is immobilized within the sol-gel matrix as it forms by engulfing the analyte or reagent template molecule. The immobilizing process relies on various molecular forces. These forces used in creating the immobilized reagent can include but are certainly not limited being based on types of adhesion forces such as Van-der-walls forces, London forces, dipole-dipole forces. The process of engulfing the template to yield functionalized Sol-Gel materials is tailored by the type of doping or grafting procedures used. The result is an immobilized reactant in a porous surface or structure. The controlled formation of the gel can result in variations within the structure of the resulting matrix, controlling variables such as porosity, matrix size, uniformity, structural dimension, and similar variables as the material is formed. One example of the process of manufacturing a Sol-Gel matrices and material can be seen in U.S. Patent Application No. 2008/0311390 to Seal, et al. The process discloses building strata on a substrate from Sol-Gel with the aforementioned gelation and hydrolysis followed by drying. This is one of several structural methodologies that can be used to form the matrix surface.

As noted above the Sol-Gel production process can result in an intermediary called xerogel in various formations that include dense films with little uniformity, uniform bulk structures, and uniform thickness, high homogeneity, thin layer structures. Any format can be used to form the matrix for the immobilization of the reactant. Thus any number of processes can be utilized to produce a sensor, however, whatever the process must also be susceptible to the additional doping of the gel with the reagent to properly immobilize the reagent as noted above. Any open matrix material that is susceptible to the immobilization of a reagent as noted will potentially function as a sensor.

In an exemplary method of forming the Sol-Gel pad or target of the instant invention a spinning process is utilized to form a thin film. The spinning process is used together with doping of reagent in the xerogel intermediary to produce the desired engulfed, immobilized reagent in a thin film matrix. These are then used in functional pads as described herein. The end result is a thin film surface trapping an immobilized analyte that reacts with a target reactant resulting in a spectrographically detectible color change. The Sol-Gel materials process is particularly useful as most reagents used are organic in nature. Such reagents are subject to photo-degradation and denaturing over time. The inert properties of Sol-Gel materials allow for encapsulation while preserving the properties of the reagent and decreasing the rate of degradation. Additionally, several of the reagents are organic dyes which are typically volatile and the low operation temperatures in manufacturing of sol-gel allow them to be infused compared to alternate techniques.

Several scientific instrument devices and some commercial and manufacturing devices have used or suggested Sol-Gel materials for chemical sensing. In one example from Oceanoptics, a sol-gel matrix material with a reagent such as bromocresol green is coated on cuvettes. The sample can now be directly placed in the cuvette and the cuvette placed in appropriate optical test equipment which is a cuvette holder coupled to light source and spectrometer, as shown on the company's website, this obviates the need to add a separate fluid reagent as the cuvette is already coated with and retains the reagent.

In a further instance, a fiber optic tester is produced whereby the process of ageing, after the addition of reagents, the matrix is coated on ends of fiber optic cables before densification. This results in a sensor that can be directly inserted in test solutions on one end and connected to optical measurement devices such as spectrometers and light sources on the other end\. Oceanoptics manufactures examples of these systems, see for example the TP-300 and RF200 probes.

However, this method of testing is limited to one off sample testing and still requires calibration to a known point before placement of the next solution in the device. This is because the devices are sensing based on the absorption of light. Therefore it is necessary for the system to understand what the path length and attenuation is from the system (cuvette holder, fiber optics, lenses etc.). In the testing process, usually a buffer of known strength is first placed in the cuvette, data on this control is then captured. This requires additional steps, materials and labor. Then the same cuvette is cleaned and the target solution is added. The new absorption values are measured. These values are used to calculate the concentrations of a target variable. This results in admission of inaccuracies and potential errors as well as requiring the admission of the control solution for calibration between each test.

To date, no one has been able to provide cost effective and efficient sensing of multiple reactants using spectrometry in a cost effective device. One that does not require consistent recalibration and can self-detect fouling and other abnormalities. Therefore, a need exists for an apparatus utilizing multiple immobilized reagents for optical sensing of reactant concentrations that is both more cost effective, requires less maintenance, requires less recalibration, allows for auto-calibration to a reference and is more accurate than existing sensor mechanisms. Such a system would provide for a higher degree of consistency, greater resolution, lower maintenance costs, and lower manufacturing costs over existing sensor systems.

### BRIEF DESCRIPTION OF THE INVENTION

An aspect of the invention includes provision for immobilized reagents in a Sol-Gel matrix for controlled retention of one or more reagents in communication with at least one target sample.

A further aspect of the invention is provision for a more cost effective multivariate mechanism for testing samples against local reasons immobilized conversions.

Yet another aspect of the invention is automation of sample testing without the need to restock or refill agents.

Another aspect of the invention is the sensing of a targeted variable with an at least one immobilized reactant and elimination of a requirement for manual calibration at every single test point.

A still further aspect is the provision of an at least one clear, non-doped sol gel pad or blank which allows the system to automatically relate the change in the system over time through to the sensor that has the doping.

Yet another aspect of the invention is multiple sensors deployed in an in-situ flow based system.

An aspect of the invention is the use of a single light source set with independent controls for each source in the set.

Yet another aspect of the invention is the use of a single light source and single sensor using the technique of indexing the pad.

The invention includes an article of manufacture, an apparatus, a method for making the article, and a method for using the article.

The apparatus of the invention includes an apparatus sensing at least two reactants or analytes in a sample, having an at least one light source emitting energy and an at least two detection targets having an immobilized reagent within the target surface. An at least one detector, wherein the at least two detection targets having immobilized reagent thereon are in communication with the sample and the immobilized reagent interacts with the sample and energy incident on the target from the at least one light source such that the energy is changed by the interaction of the reagent and reactant and the change is in turn detected by the at least one detector and associated with a measurement of the level of the reactant or analyte in the sample.

The at least one target surface can be a matrix formed by the sol-gel technique. The apparatus may have a blank target or a target without immobilized reactant for calibration of the sensors using the at least one light source emitting energy. The at least one light source can be two or more light sources.

The emitted energy can be in at least one of the visible light, ultra violet, or infrared spectrums. The at least one light source can be a single light source. The at least one detector can be a single detector. The at least one detector can also be two or more detectors. The at least one light source can be a single light source and the at least one detector can be a single detector and the at least two targets are indexed and moved to interact with the energy emitted by the single light source and detected by the single detector.

The at least two targets can be indexed in a rotary indexer with a rotary indexing support. The at least two targets can be indexed in a linear indexer with a linear indexing support. The at least one light source can be a broad band light source emitting over multiple frequencies, wavelengths, or frequencies and wavelengths. The at least one light source can be a narrow band light source emitting small bands of energy at a specific frequency, wavelength, or frequency and wavelength. The at least one light source can be two or more light sources having a narrow band.

The apparatus may further include a controller. The controller can interrogate data from the at least one detector, analyze the data and correlates the data to a desired variable level.

The apparatus can include an at least one sample vessel. The sample can be a single sample. The single sample can contained within multiple vessel sections in the at least one vessel. The single sample can be contained in a single vessel section. The vessel can be transparent or semi-transparent to the energy emitted by the at least one light source.

The energy can be passed through the targets and can be detected by the at least one detectors on a side opposite the at least one light source. An at least one wall of the vessel can reflect the energy emitted by the at least one light source. The at least one light source can be on one side of the vessel and the energy can be emitted and isolated within a light tube portion of the vessel and is incident on a reflective surface, which is then reflected from said at least one wall through the at least two targets to the at least one detector. The energy emitted by the at least one light source can be collected by the detectors directly from the at least two targets within the solution.

The at least one detector can be an at least one spectrophotometer and a photodetector The detector can be at least one of a CMOS, CCD, Photodiode, Photoresistor, Phototransistor, and a Phototube. The at least one detector can further comprise an at least one filter. The filter can be at least one of an at least one absorptive or dichroic filter. The at least one filter includes a combination of filters reacting to specific wavelength bands to filter and detect color sensing.

The matrix can be formed using a metal alkoxide or a metal alkyloxide precursor compound. The reagent can be immobilized by at least one of Van-der-Walls force, London Forces, dipole-dipole forces, and dispersion forces within the target. The reagents can be an at least one of an organic dye, an inorganic dye, bromocresol green, cresol red, bromothymol blue, bromopyrogallol red, phenol red, orthotolidine, N—N, diphenyl-p-phenylenediamine, and melamine. The reagents can be an at least one of an at least one enzyme, Aequorin, Chloramine, and Glucose Oxidase. The reagent can activate when near an at least one of hydronium, chlorine, calcium, iron, sodium, lead bromine, magnesium, and copper. The reagents can measure at least one of oxygen, carbon-dioxide, cyanuric acid, chlorine, and glucose concentrations. The reagents can be at least one of flora and fauna. The flora can be algae or bacteria. The immobilized reagent can chemically bond to the matrix by a bond such as covalent bond, hydrogen bond or ionic bond.

The apparatus of the invention further includes a sensing apparatus having an at least one light source emitting energy with an at least one detection target having an immobilized reagent within the target surface and an at least one detection target having no reagent. An at least one detector can be provided, wherein the at least one detection target having immobilized reactants and the at least one detection target having no reagent are in communication with the sample and the immobilized reagent interacts with the sample and energy incident from the at least one light source can be changed by the interaction and the change can be in turn detected by the at least one detector and associated with a measurement of the level of the reactant or analyte in the sample and calibrated against a reference energy profile received by the at least one detector from the at least one target having no reagent.

The at least one target surface can further include a matrix formed by the sol-gel technique. The emitted energy can be in at least one of the visible light, ultra violet, or infrared spectrums. The at least one light source can be a single light source and the at least one detector can be a single detector and the at least one target with the immobilized reagent can be indexed and moved to interact with the energy emitted by the single light source and detected by the single detector. The at least one target with immobilized reagent and the at least one target with no reagent can be indexed in a rotary indexer with a rotary indexing support.

The apparatus can further include a controller. The controller can interrogates data from the at least one detector, analyzes the data and correlates the data to a desired variable level. The sample can be a single sample. The single sample can be contained within multiple vessel sections in the at least one vessel. The reagents can be an at least one of an organic dye, an inorganic dye, bromocresol green, cresol red, bromothymol blue, bromopyrogallol red, phenol red, orthotolidine, N—N, diphenyl-p-phenylenediamine, and melamine. The reagents can be an at least one of an at least one enzyme, Aequorin, Chloramine, and Glucose Oxidase. The reagent can activate when near an at least one of hydronium, chlorine, calcium, iron, sodium, lead bromine, magnesium, and copper. The reagents can measure at least one of oxygen, carbon-dioxide, cyanuric acid, chlorine, and glucose concentrations. The reagents can be at least one of flora and fauna. The flora can be algae or bacteria.

The method of the invention includes a method of sensing, having the steps of: placing a sample in a vessel in contact with an at least two detection targets having an immobilized reagents thereon; directing an at least one light source incident upon the at least two detection targets having immobilized reagents thereon; emitting energy from the at least one light source incident upon the at least two detection targets having immobilized reagents thereon such that the energy changes with any interaction the immobilized reagents have with the sample; detecting a change in the energy incident upon the at least two detection targets having immobilized reagents caused by the interaction of the immobilized reagents with the sample; and reporting the results of the detection step.

The article of manufacture of the invention includes an apparatus sensing a change in an optical profile from an at least one detection target having an immobilized reagent within at least one surface of the detection target prepared by the process steps of forming a sol-gel matrix adding a reagent into the matrix and immobilizing the reagent within the matrix; forming an at least one surface with an at least one detection target having the immobilized reagent on the at least one surface; placing the at least one detection target having the immobilized reagent on the at least one surface in a sample vessel; placing an at least one detection target having no reagent in the sample vessel; and calibrating at least one detection target having the immobilized reagent using data detected from the at least one detection target having no reagent.

The matrix can be a thin film. The thin film can be formed by spin coating or dip coating process. The matrix can be a bulk target. The article may be further prepared with the step of adding a reagent during manufacture. The sol-gel material can be prepared via sol-gel processing involving the generation of colloidal suspensions which are subsequently converted to viscous gels and then to solid materials. The porosity of the matrix is controlled during the sol-gel processing via control of at least one of a pH, a temperature and addition of selective surfactants during conversion to viscous gels and then solid materials. The surfactants can be at least one of cationic trumethyl ammonium bromide or anionic sodium dodecyl sulfate.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings, where the same reference numerals refer to the same features.

FIG. 1 shows a cross section of an exemplary embodiment of this invention having an at least one light source being two light sources incident upon at least two immobilized reagents targets.

FIG. 2 shows a cross section of a further exemplary embodiment having an at least one light source being a single light source incident upon at least two immobilized reagent targets.

FIG. 3 shows a cross section of yet another exemplary embodiment wherein the at least one light source is a single incident light source with an indexing mechanism.

FIG. 4 shows a perspective view of an exemplary embodiment of a circular support member for a rotary indexing mechanism.

FIG. 5 shows a cross section of yet another exemplary embodiment wherein the at least one light source is a single incident light source with a linear indexing mechanism.

FIG. 6 shows a perspective view of an exemplary embodiment of a linear indexing support member for a linear indexing mechanism.

FIG. 7 shows a cross-section of still another exemplary embodiment of the instant invention having a single light source isolated from the at least two samples and reflecting energy back onto an at least two targets in a sample.

FIG. 8 shows a cross-section of still another exemplary embodiment of the instant invention having a single light source and an at least one detector on the same side of the sample directly observing an at least two targets within the sample in the sample vessel.

FIG. 9 is a chart showing a spectral profile of an exemplary embodiment for a single broad spectrum light source.

FIG. 10 is a further chart showing a spectral profile of multiple light sources in an exemplary embodiment providing a controllable wavelength selection capability.

FIG. 11 shows a plan view of an exemplary embodiment of this invention.

### DETAILED DESCRIPTION OF INSTANT INVENTION

FIG. 1 shows a cross section of an exemplary embodiment of this invention having an at least one light source being two light sources incident upon at least two immobilized reagents targets. The exemplary embodiment of the invention having at least one light source incident upon an at least two immobilized reagent pads or targets with optical sensors analyzing changes in the energetic emanations of the incident at least one light source on the targets. As shown in FIG. 1 an at least two targets or pads with reagents immobilized therein 130, 160 are provided in communication with the sample solution 100. As described herein above the targets with immobilized analytes 130, 160 are in the exemplary embodiment Sol-Gel based thin film matrices developed to retain the regents in the matrix and the reagents are immobilized allowing the reactive agents within the sample 100 to interact with the immobilized reagents and produce changes in properties affecting the radiated energy from the at least one light source. Although reference is made to thin films, other structures can be used that have the ability to immobilize a reagent, including for example but certainly not limited to bulk sol-gel material and other materials having a matrix structure capable of immobilizing a reagent. Some non-limiting examples of the forces that can immobilize a reagent include but are certainly not limited to one or more of an electromotive force such as Van-der-Walls force, London Forces, dipole-dipole forces, dispersion forces and the like or one or more chemical bonds such as hydrogen bonds, covalent bonds, ionic bonds and the like alone or in conjunction with one another.

A chemical or physical reaction occurs between a reactant in concentration in the sample, something indicating a desired property of the sample that is to be measured. Reagents can include, but are certainly not limited to organic or inorganic dyes such as but not limited to, bromocresol green, cresol red, bromothymol blue, bromopyrogallol red, phenol red, orthotolidine, N—N, diphenyl-p-phenylenediamine, melamine or enzymes such as, but certainly not limited to Aequorin, Chloramine, Glucose Oxidase and the like, used alone or in any functional combination. The reagent-reactant activity measures for a variable. Variables can be for example, but certainly are certainly not limited to, dissolved analytes that can be ions such as hydronium, chlorine, calcium, iron, sodium, lead bromine, magnesium, copper, and the like; or dissolved analytes that can be compounds such as oxygen, carbon-dioxide, cyanuric acid, chlorine, glucose and the like; or flora and fauna such as algae, bacteria, and the like, alone or together in any functional combination. This occurs without the loss or absorption of the immobilized analytes in the matrices of each of the targets 130, 160. The targets are suspended on or within a further support member 210 which isolates the targets 130,160. As noted above, the exemplary embodiment employs a Sol-Gel process to provide a matrix with immobilized reagents that interact with target reactants to instigate a detectable change in an energy emission as measured by a detector.

Again, Sol-Gel is a method for forming a lattice structure which can be, but is certainly not limited to, Silicon Dioxide (SiO2) or titanium dioxide (TiO2) thin films deposited by the Sol-Gel technique. As noted surface structures and solids with the immobilized reagents throughout are also considered as are other Sol-Gel structures that immobilize reagents that can then be admitted to and interact with the sample, thereby acting as a sensor.

In an exemplary embodiment, the Sol-Gel process starts from titanium oxy-acetyl acetonate precursor or tetraethyl oxysiliane with solvents added thereto to eventually form a titanium dioxide or silicon dioxide thin film. The Sol-Gel components are combined to form into the intermediary xerogel, the analyte molecule is inserted, and the result is an engulfed analyte bound in the matrix. The xerogel is dispersed into a thin layer form and dried to form the final target pad surface. Some non-limiting examples of process for dispersing the xerogel include spinning, vapor deposition, dipping and the like. The xerogel, as a non-limiting example, is typically built on a substrate, such as that suggested in U.S. Patent Application 2008/0311390 to Seal, et al.

However, other examples of Sol-Gel have included fiber optic structures and bulk material structures can be formed and either exposed surfaces can be used or the bulk material may be sectioning to appropriate sensor targets with matrix structures immobilizing reagents as noted above. The matrix effectively immobilizes the reagent in the structure and renders the surface of the pad reactive to particularized reactants of interest for identifying physical variables of the solution, such as pH, temperature, salinity, free chlorine, and other variables as noted herein. The interaction becomes evident through spectrographic analysis as explained herein, typically through an absorption process or a fluorescing process, identified by the at least one detector 180,190. The at least one detector can be, but is certainly not limited to an at least one spectrophotometer and a photodetector. Non-limiting examples of a photodetector include an at least one of a CMOS chips, CCD chips, photodiodes, photoresistors, phototransistors, phototubes and the like.

In this instance, exemplary embodiment of FIG. 1 provides at least one light source, here two distinct light sources 110, 120, incident on each of the at least two targets 130,160. Although referred to as a light source, the at least one light source can project visible light as just one non-limiting example. The term light source however includes any radiated energy source which will have a measurable change when incident upon the immobilized analyte and reactant producing the reaction in the sample and for which this change is detectable by the at least one associated detectors. This can also include, but is certainly not limited to, ultra-violet, infra-red, and visible light as well as other types and frequencies of radiation including for example but certainly not limited to other energetic waves such as ultrasonic emanations and the like. An at least one detector is provide, here each source of the exemplary embodiment has a detector 180 and 190 opposite the at least two incident light sources 110, 120

The sample 100 that is to be measured is suspended in an optically clear sample vessel 200. The sample vessel 200 with the sample 100 is shown as being unhindered, however, it is well within the spirit of the invention to provide sectioning of the sample 100 within the sample vessel 200 and/or provide sectioning of the at least one light source 110, 120 and the at least one detector 180, 190 and the combinations and exemplary embodiments shown herein are simply non-limiting examples of the types of structure embraced by the instant invention. In addition, the sample 100 though stationary in FIG. 1 may also be moved or moving via a pump or similar motivating device or configuration without departing from the spirit of the invention.

Thus, in the exemplary embodiment of FIG. 1 as shown, the optically clear, transparent, or semi-transparent sample vessel 200 allows for penetration of each incident light source onto and through the targets or pads 130, 160 and the interaction of the immobilized analytes with the reactants in the solution 100 result in measurable variables in the spectrographic qualities of the light, for instance the absorption of the light or wavelengths of light by the target or pads 130, 160, received by the at least one detector, here the two detectors 180, 190 across from the at least one source, here light sources 110, 120. The at least one detector 180, 190 in turn measures the spectrographic change and reports this to a user (not shown) or a controller, as better seen in FIG. 11, which interprets the measurements and produces a resulting concentration of a reactant in the sample 100 based on these measurements.

FIG. 2 shows a cross section of a further exemplary embodiment having an at least one light source being a single light source is incident upon at least two immobilized targets. FIG. 2 shows a further exemplary embodiment very similar to FIG. 1, providing a sample 100 with at least two reactants, at least two targets with immobilized reagents 130, 160, at least one detector again here two detectors 180, 190, and a clear sample vessel 200. However, a single incident light source 110 is provided engaging with the target pads 130, 160 and passing through and being incident up the detectors 180, 190. The detectors detecting the changes from the incident at least one light source, again here a visible light source, which has a variation in the absorption of the radiated light being measured by the detectors 180, 190.

FIG. 3 shows a cross section of yet another exemplary embodiment wherein the at least one light source is a single incident light source with an indexing mechanism. FIG. 3 shows yet a further exemplary embodiment of the instant invention utilizing a rotary motor 220 and specialized support member 210. In the embodiment shown an at least two targets with immobilized reagents 130, 160 are coupled through the support member 210 to a drive mechanism 225 and an at least one rotary motor 220 and remain held within the sample 100 contained within the sample vessel 200. An at least one light source 110 is provided and incident on the first of the at least two targets 130. The energy emitted by the at least one light source 110 interacts with the first of the at least two targets 130 and the interaction is detected by the at least one detector 180. The at least one detector 180 can for instance be a complex spectrometer or simply a CCD camera detecting for example, but certainly not limited to, the absorption of specific wavelengths of the energy or color shifts and the like.

In the exemplary embodiment of FIG. 3, the embodiment allows for measurement of a second reactant through the second of the at least two targets 160 by engaging the motor 220 to index the at least two targets and move the second of the at least two targets 160 into alignment with that at least one light source 110 and the at least one detector 180. The second of the at least two targets 160 interacts with the at least one light source 110 to produce another, different reaction measurable by the detector 180. The at least two targets 130, 160 are in synchronization with the at least one light source 110 and at least one detector 180 so as to begin measurement once the appropriate target is aligned.

In addition to the at least two targets 130, 160 a blank 103, either a Sol-Gel target without an immobilized reagent or a blank space or material, can be incorporated to be used for calibration purposes, as further shown in FIG. 4. The blank 103 would allow for a known profile of the radiated energy from the at least one light source 110 to be received by the at least one target 180. The blank 103 can be used, for example but certainly not limited to, at least one of calibrating the at least one light source 110, calibrating the at least one detector 130, 160 and analyzing the state of the sample 100. Variations from the expected profile can result in automatic adjustment or an alert to be sent regarding calibration of the device. The blank 103 would also be able to detect degradation in the targets, light source or turbidity in the sample for example.

FIG. 4 shows a perspective view of an exemplary embodiment of a circular support member for a rotary indexing mechanism. The support member 210 is shown as a circular indexing wheel supporting eight slots for the at least two targets 101-108. An at least one indexing marker 203 is provided such that a counting mechanism (not shown) can count the spaces indexed on the wheel shaped support member 210. A hub 300 couples the support member 210 to an indexing motor 400. Each slot for the at least two targets 101-108 provides for use of a different target with a different immobilized reagent, allowing up to eight test targets and thereby measurements of reactants or solutes. Again, provision can be made for a blank or calibration target, for instance slot 103 could be a clear/untreated target for calibration as noted above.

FIG. 5 shows a cross section of yet another exemplary embodiment wherein the at least one light source is a single incident light source with a linear indexing mechanism. A further exemplary embodiment is shown with a linear indexing element. Again an at least one light source, here a single light source 110 is provided with a corresponding at least one detector 180. Again the sample 100 is contained within a vessel 200 which is transparent to the radiation allowing the energy of the at least one light 110 to pass through the slots for the at least two targets 130, 160. A movement member 235 is coupled to the support member 210, as shown in the exemplary embodiment. The movement member 235 is also coupled to a linear actuator 230. The system again exposes the first of the at least one target 130 to incident energy from the at least one light source 110. This interacts with the sample at the site of the interaction between the reactant and the immobilized analyte, creating a measurable change for the detector 180.

In the exemplary embodiment shown, the measurement is completed for the first of the at least two immobilized reagent targets 130, 160 and either through user input or sensor measurement, moves the movement member 235 and thereby indexes the targets in the tray, herein the second of the at least two targets 160 is moved into position above the detector 180. The indexing, being linear, can also occur in the opposite direction so long as the subject target of the at least two immobilized analyte targets is synchronized with the at least one light source 110 and the at least one detector 180.

FIG. 6 shows a perspective view of an exemplary embodiment of a linear indexing support member for a linear indexing mechanism. FIG. 6 shows an exemplary embodiment of a linear indexing support tray 210 having at least two immobilized reagent targets 101-108 thereon for use with a linear or indexing mechanism such as that of FIG. 5. FIG. 6 shows the linear actuating arrangement or tray having slots for an at least two immobilized reagent target or pad 101-108 and support member 410. The indexing tray has markers or notches 205, 208 to identify a direction of travel/stepping of the tray.

FIG. 7 shows a cross-section of still another exemplary embodiment of the instant invention having a single light source isolated from the at least two samples and reflecting energy back onto an at least two targets in a sample. In the exemplary embodiment shown an at least one light source 110, again here depicted as a single light source, is isolated within a cavity 115 having opaque walls 122, 124. A support structure 210 holds the at least two target pads. The light shines into a sample vessel 200. An at least two immobilized reagent test pads 130, 160 are provided. As the energy from the at least one light source 110 is projected, it is incident on the wall of the sample vessel 240. The wall 240 of the sample vessel 200 can be reflective or highly polished so as to reflect a sufficient portion of the radiated energy back through the at least two target pads 130, 160. Similarly, the wall 240 can also have a coating with specific photometric properties and effectively selectively reflect and/or absorb energy. For instance, the material can be a specific filter material or can be a filter material only when an electrical current is passed through the wall or similar static or transient properties as desired. Some non-limiting examples of filters, which can be coatings on the vessel or separate structures spaced between the at least two targets 130, 160 and the at least one detector 180, 190, include for example but are not limited to absorptive, dichroic or similar filters. The at least two detectors are provided 180, 190 to sense changes in the spectrographic characteristics and respond thereto.

FIG. 8 shows a cross-section of still another exemplary embodiment of the instant invention having a single light source and an at least one detector on the same side of the sample 100 directly observing an at least two targets within the sample in the sample vessel. The embodiment of FIG. 8 is similar to that of FIG. 7, however the at least one detector, here detectors 180, 190, are detecting the observable interaction of the energy emitted by the at least one light source 110 directly at the at least one immobilized reagent target 130, 160, for instance the at least one light source can be visible light and the detectors 180, 190 can be a CCD camera recording the color at the targets 130, 160. The light (dotted lines) incident from the light source 110 still penetrates the vessel 200 and the sample 100 to the at least one target 130, 160 mounted the support 210. Only the incidence of measurement instead of measuring light passed through the target is instead measuring light directly from the target.

FIG. 9 is a diagram of a spectral profile of an exemplary embodiment for a single broad spectrum light source. In this figure a typical absorption spectrum is shown that is detected as energy being emitted and incident on the target pad from a single broad band pass light source. Examples of a source for such a broadband light source can include, but are certainly not limited to, incandescent lights, halogen lights, white (phosphorous coated) lights, LEDs, HID, and the like. The profile represents an intensity received relative to wavelengths. In the case of a broad band light source, a wide range of wavelengths is provided with a relatively consistent intensity across the curve 450.

When an interaction of an immobilized reagent within the at least two targets 130, 160 and a reactant in solution occurs, a change in a portion of the curve 450 will occur exhibiting a change in the curve. One non-limiting example of such a change would be an absorption phenomenon, which would result in a marked reduction in the intensity of certain wavelengths of light being received at the at least one detector 180,190. Similarly, other phenomenon can increase the intensity of some wavelengths or simultaneously decrease intensity at one wavelength and increase the intensity at another wavelength. For instance, instead of simple absorption, a fluorescence phenomenon can be noted. As noted, these can occur in any number of wavelength ranges for the given at least one light source. In the exemplary embodiment shown, this would result in an optical reaction that is detectable by the at least one detector 180, 190 and reportable as a change that indicates to the detection of a desired reactant and thereby correlates to a relative scale of a desired variable or characteristic of the sample 100. This may be further enhanced as noted above by the use of filters on the light to during the course of its travels from source to detector using the filter to amply or depress specific wavelengths or regions of the profile 450.

FIG. 10 is a further diagram of a spectral profile of multiple light sources in an exemplary embodiment providing a controllable wavelength selection capability. Similar to FIG. 9, the figure shows a spectrographic profile, however this profile involves energy at specific wavelengths for multiple independently controlled sources. Unlike FIG. 9, the profile shown for FIG. 10 is for multiple narrow band light or energy sources. The use of narrow or broad band light sources is fully contemplated and these can be used in conjunction with one another, alone or in any myriad of combinations, to provide the requisite incident energy for spectrometric analysis of the resulting light incident on the analyte and reactant interaction. In the profile example shown in FIG. 10, several intensity “peaks” show where specific, narrow band light sources are emitting energy 410, 420, 430 in bands around specific wavelengths. These in turn are at specified wavelengths with specific dispersal across the profile. The result is that when the analyte-reactant interaction occurs, a change in this pattern will occur in one or more of these sources and be detectable as an indicator of the reactant in the solution 100. This will again be correlated to a specific target variable being detected by the sensor.

FIG. 11 shows a plan view of an exemplary embodiment of this invention. A controller 600 is provided with a power management component 601 and a communications component 603. The controller 600 controls a light source driver 620 which is communication with an at least one light source 621-626. These light sources 621-626 in the exemplary embodiment can emit different bands of wavelength and the light source driver 620 is able to independently drive the light sources 621-626 at desired intensity.

The light sources emit light that is incident on an at least one target 610, 611 having an immobilized reagent that reacts with reactants in the sample as an indicator of properties of the sample. This interaction is measured as a change in the spectrographic absorption at the at least one target 610, 611 and this change is detected by an at least one sensor 606-608. Similarly, a calibration or reference window 615 is provided with a target that is clear or has no doping of an immobilized reagent or is otherwise non-reactive with the reactant 615 which likewise receives energy from the at least one light source 621-626 but does not have an interaction occurring that changes the energy. The reference window 615 acts as a calibration target and passes the known light profile emanating from the at least one light source 621-626. Variations in this profile indicate calibration issues which may result from conditions in the sample, for instance but not limited to turbidity, conditions in the at least one light source, for instance but not limited to light source degradation or malfunction, or when compared to other sensor results may be able to provide identification of sensor malfunctions. The at least one target component 610, 611, 615 can be removed from the system and replaced or changed to suit the environment and use of the sensor system.

Though multiple light sources are provided, a single light source may also be provided. In this exemplary embodiment, the multiple light sources 621-626 are individually addressable sources that are driven by the light source driver 620 in communication with the controller 600. The individual lights 621-626 in this case can provide light of specific narrow bands of wavelengths based on instructions from the light driver 620. The use of narrow or broad band light sources is fully contemplated and these can be used in conjunction with one another, alone or in any myriad of combinations, to provide the requisite incident energy for spectrometric analysis of the resulting light incident on the analyte and reactant interaction. These will in turn create a profile of intensity over a wavelength band, as seen in previous FIGS. 9 and 10, having specific levels of intensity across the profile for individual reactants with the reagents. The result is that when the reagent-reactant interaction occurs, a change in this pattern will occur in one or more of these sources and be detectable as an indicator of the reactant in the water. This is correlated to a specific target variable being detected by the sensors 606-608 and the controller 600.

In addition the controller 600 is in communication with at least one temperature sensor, thermistor, thermopile, infrared sensing, thermocouple and the like 640, at least one salinity sensor 634, and at least one displacement based flow sensor, differential pressure sensor, inductive flow sensor, coriolis flow sensor, ultrasonic flow sensor, calorimetric flow sensor and the like. 645. These additional sensors 634, 640 located in a vessel 105. The vessel 105 has a first wall 631 a second wall 632 the sensor arrangement has immobilized reagent targets 610, 611 contained therein.

The controller 600 is in further communication with a signal conditioning circuit 605 which feeds signals from the at least one detector 606, 607, 608 to the controller 600. The controller analyzes the variables relating to the various reagent-reactant reactions being detected by the at least one detector 606-608 and communicates the results through the communication component 603. This can be communicated to a user interface, to a user via visual observation, or off from this controller 600 via a wired or wireless connection to a further controller.

The embodiments and examples discussed herein are non-limiting examples. The invention is described in detail with respect to preferred embodiments, and it will now be apparent from the foregoing to those skilled in the art that changes and modifications can be made without departing from the invention in its broader aspects, and the invention, therefore, as defined in the claims is intended to cover all such changes and modifications as fall within the true spirit of the invention.

What is claimed is:

1. An apparatus sensing at least two reactants or analytes in a sample, comprising:
an at least one light source emitting energy;
an at least two detection targets having an immobilized reagent within the target surface;
an at least one detector, wherein the at least two detection targets having immobilized reagent thereon are in communication with the sample and the immobilized reagent interacts with the sample and energy incident on the target from the at least one light source such that the energy is changed by the interaction and the change is in turn detected by the at least one detector and associated with a measurement of the level of the reactant or analyte in the sample.

2. The apparatus sensing at least two reactants of claim 1, wherein the at least one target surface comprises a matrix formed by the sol-gel technique.

3. The apparatus sensing at least two reactants of claim 1, further comprising a blank target or a target without immobilized reactant for calibration of the sensors using the at least one light source emitting energy.

4. The apparatus sensing at least two reactants of claim 1, wherein the at least one light source is two or more light sources.

5. The apparatus sensing at least two reactants of claim 1, wherein the emitted energy is in at least one of the visible light, ultra violet, or infrared spectrums.

6. The apparatus sensing at least two reactants of claim 1, wherein the at least one light source is a single light source.

7. The apparatus sensing at least two reactants of claim 1, wherein the at least one detector is a single detector.

8. The apparatus sensing at least two reactants of claim 1, wherein the at least one detector is two or more detectors.

9. The apparatus sensing at least two reactants of claim 1, wherein the at least one light source is a single light source and the at least one detector is a single detector and the at least two targets are indexed and moved to interact with the energy emitted by the single light source and detected by the single detector.

10. The apparatus sensing at least two reactants of claim 1, wherein the at least two targets are indexed in a rotary indexer with a rotary indexing support.

11. The apparatus sensing at least two reactants of claim 1, wherein the at least two targets are indexed in a linear indexer with a linear indexing support.

12. The apparatus sensing at least two reactants of claim 1, wherein the at least one light source is a broad band light source emitting over multiple frequencies, wavelengths, or frequencies and wavelengths.

13. The apparatus sensing at least two reactants of claim 1, wherein the at least one light source is a narrow band light source emitting small bands of energy at a specific frequency, wavelength, or frequency and wavelength.

14. The apparatus sensing at least two reactants of claim 13, wherein the at least one light source is two or more light sources having a narrow band.

15. The apparatus sensing at least two reactants of claim 1, further comprising a controller.

16. The apparatus sensing at least two reactants of claim 15, wherein the controller interrogates data from the at least one detector, analyzes the data and correlates the data to a desired variable level.

17. The apparatus sensing at least two reactants of claim 1, further comprising an at least one sample vessel.

18. The apparatus sensing at least two reactants of claim 17, wherein the sample is a single sample.

19. The apparatus sensing at least two reactants of claim 18, wherein the single sample is contained within multiple vessel sections in the at least one vessel.

20. The apparatus sensing at least two reactants of claim 18, wherein the single sample is contained in a single vessel section.

21. The apparatus sensing at least two reactants of claim 1, wherein the vessel is transparent or semi-transparent to the energy emitted by the at least one light source.

22. The apparatus sensing at least two reactants of claim 1, wherein the energy passes through the targets and is detected by the at least one detectors on a side opposite the at least one light source.

23. The apparatus sensing at least two reactants of claim 1, wherein an at least one wall of the vessel reflects the energy emitted by the at least one light source.

24. The apparatus sensing at least two reactants of claim 23, wherein the at least one light source is on one side of the vessel and the energy is emitted and isolated within a light tube portion of the vessel and is incident on a reflective surface, which is then reflected from said at least one wall through the at least two targets to the at least one detector.

25. The apparatus sensing at least two reactants of claim 1, wherein the energy emitted by the at least one light source is collected by the detectors directly from the at least two targets within the solution.

26. The apparatus sensing at least two reactants of claim 25, wherein the at least one detector is an at least one spectrophotometer and a photodetector

27. The apparatus sensing at least two reactants of claim 25, wherein the detector is at least one of a CMOS, CCD, Photodiode, Photoresistor, Phototransistor, and a Phototube

28. The apparatus sensing at least two reactants of claim 1, wherein the at least one detector further comprises an at least one filter.

29. The apparatus sensing at least two reactants of claim 1, wherein the filter is at least one of an at least one absorptive or dichroic filter.

30. The apparatus sensing at least two reactants of claim 29, wherein the at least one filter includes a combination of filters reacting to specific wavelength bands to filter and detect color sensing.

31. The apparatus sensing at least two reactants of claim 1, wherein the matrix is formed using a metal alkoxide or a metal alkyloxide precursor compound.

32. The apparatus sensing at least two reactants of claim 1, wherein the reagent may be immobilized by at least one of Van-der-Walls force, London Forces, dipole-dipole forces, and dispersion forces within the target.

33. The apparatus sensing at least two reactants of claim 1, wherein the reagents are an at least one of an organic dye, an inorganic dye, bromocresol green, cresol red, bromothymol blue, bromopyrogallol red, phenol red, orthotolidine, N—N, diphenyl-p-phenylenediamine, and melamine.

34. The apparatus sensing at least two reactants of claim 1, wherein the reagents are an at least one of an at least one enzyme, Aequorin, Chloramine, and Glucose Oxidase.

35. The apparatus sensing at least two reactants of claim 1, wherein the reagent activates when near an at least one of hydronium, chlorine, calcium, iron, sodium, lead bromine, magnesium, and copper.

36. The apparatus sensing at least two reactants of claim 1, wherein the reagents measures at least one of oxygen, carbon-dioxide, cyanuric acid, chlorine, and glucose concentrations.

37. The apparatus sensing at least two reactants of claim 1, wherein the reagents are at least one of flora and fauna

38. The apparatus sensing at least two reactants of claim 36, wherein the flora is algae or bacteria.

39. The apparatus of claim 1, wherein the immobilized reagent is chemically bonded to the matrix by a bond such as covalent bond, hydrogen bond or ionic bond.

40. A sensing apparatus, comprising:
an at least one light source emitting energy;
an at least one detection target having an immobilized reagent within the target surface;
an at least one detection target having no reagent;
an at least one detector, wherein the at least one detection targets having immobilized reactants and the at least one detection target having no reagent are in communication with the sample and the immobilized reagent interacts with the sample and energy incident from the at least one light source is changed by the interaction and the change is in turn detected by the at least one detector and associated with a measurement of the level of the reactant or analyte in the sample and calibrated against a reference energy profile received by the at least one detector from the at least one target having no reagent.

41. The apparatus sensing at least two reactants of claim 40, wherein the at least one target surface comprises a matrix formed by the sol-gel technique.

42. The apparatus sensing at least two reactants of claim 40, wherein the emitted energy is in at least one of the visible light, ultra violet, or infrared spectrums.

43. The apparatus sensing at least two reactants of claim 40, wherein the at least one light source is a single light source and the at least one detector is a single detector and the at least one target with an immobilized reagent is indexed and moved to interact with the energy emitted by the single light source and detected by the single detector.

44. The apparatus sensing at least two reactants of claim 40, wherein the at least one target with immobilized reagent and the at least one target with no reagent are indexed in a rotary indexer with a rotary indexing support.

45. The apparatus sensing at least two reactants of claim 40, further comprising a controller.

46. The apparatus sensing at least two reactants of claim 45, wherein the controller interrogates data from the at least one detector, analyzes the data and correlates the data to a desired variable level.

47. The apparatus sensing at least two reactants of claim 40, wherein the sample is a single sample.

48. The apparatus sensing at least two reactants of claim 47, wherein the single sample is contained within multiple vessel sections in an at least one vessel.

49. The apparatus sensing at least two reactants of claim 40, wherein the reagents are an at least one of an organic dye, an inorganic dye, bromocresol green, cresol red, bromothymol blue, bromopyrogallol red, phenol red, orthotolidine, N—N, diphenyl-p-phenylenediamine, and melamine.

50. The apparatus sensing at least two reactants of claim 40, wherein the reagents are an at least one of an at least one enzyme, Aequorin, Chloramine, and Glucose Oxidase.

51. The apparatus sensing at least two reactants of claim 1, wherein the reagent activates when near an at least one of hydronium, chlorine, calcium, iron, sodium, lead bromine, magnesium, and copper.

52. The apparatus sensing at least two reactants of claim 40, wherein the reagents measures at least one of oxygen, carbon-dioxide, cyanuric acid, chlorine, and glucose concentrations.

53. The apparatus sensing at least two reactants of claim 40, wherein the reagents are at least one of flora and fauna

54. The apparatus sensing at least two reactants of claim 40, wherein the flora is algae or bacteria.

55. A method of sensing, comprising the steps of:
placing a sample in a vessel in contact with an at least two detection targets having an immobilized reagents thereon;
directing an at least one light source incident upon the at least two detection targets having immobilized reagents thereon;
emitting energy from the at least one light source incident upon the at least two detection targets having immobilized reagents thereon such that the energy changes with any interaction the immobilized reagents have with the sample;
detecting a change in the energy incident upon the at least two detection targets having immobilized reagents caused by the interaction of the immobilized reagents with the sample; and
reporting the results of the detection step.

56. An apparatus sensing a change in an optical profile from an at least one detection target having an immobilized reagent within at least one surface of the detection target, prepared by the process steps of:
forming a sol-gel matrix;
adding a reagent into the matrix and immobilizing the reagent within the matrix;
forming an at least one surface with an at least one detection target having the immobilized reagent on the at least one surface;
placing the at least one detection target having the immobilized reagent on the at least one surface in a sample vessel;
placing an at least one detection target having no reagent in the sample vessel; and
calibrating at least one detection target having the immobilized reagent using data detected from the at least one detection target having no reagent.

57. The apparatus of claim 56, wherein the matrix is a thin film

58. The apparatus of claim 57, wherein the thin film is formed by spin coating or dip coating process.

59. The apparatus of claim 56, wherein the matrix is a bulk target

60. The apparatus of claim 56, further comprising the step of adding a reagent during manufacture.

61. The apparatus of claim 60, wherein the sol-gel material is prepared via sol-gel processing involving the generation of colloidal suspensions which are subsequently converted to viscous gels and then to solid materials.

62. The apparatus of claim 61, wherein the porosity of the matrix is controlled during the sol-gel processing via control of at least one of a pH, a temperature and addition of selective surfactants during conversion to viscous gels and then solid materials.

64. The apparatus of claim 62, wherein the surfactants are at least one of cationic trumethyl ammonium bromide or anionic sodium dodecyl sulfate.
